(19) United States
(12) Patent Application Publication
(10) Pub. No.: US 2024/0295247 A1
(43) Pub. Date: Sep. 5, 2024

(54) DRUM BRAKE AND BRAKING MEMBER

(71) Applicant: Hitachi Astemo, Ltd., Hitachinaka-shi, Ibaraki (JP)

(72) Inventor: Hideaki ISHII, Hitachinaka-shi, Ibaraki (JP)

(21) Appl. No.: 18/573,037

(22) PCT Filed: Jun. 30, 2022
(86) PCT No.: PCT/JP2022/026163

§ 371 Date: Dec. 21, 2023

(30) Foreign Application Priority Data
Jul. 8, 2021 (JP) 2021-113249

(51) Int. Cl. F16D 65/22; F16D 51/24; F16D 51/50; F16D 65/09; F16D 121/04; F16D 121/24

(52) U.S. Cl. CPC F16D 65/22; F16D 51/24; F16D 51/50; F16D 65/09; F16D 2121/04; F16D 2121/24

(57) ABSTRACT

A brake shoe brakes a drum rotor by being pressed against an inner peripheral surface of the drum rotor. A friction material of the brake shoe includes a first lining material, a second lining material, and a third lining material. The first lining material is one end portion of the friction material in an arc shape opposing the inner peripheral surface of the drum rotor in a rotation direction of the drum rotor. The second lining material is another end portion of the friction material in the rotation direction of the drum rotor. The third lining material is positioned between the one end portion and the another end portion in the rotation direction of the drum rotor, and is produced such that the third lining material wears earlier than the first lining material and the second lining material.

### TECHNICAL FIELD

The present disclosure relates to a drum brake and a braking member.

### BACKGROUND ART

In Patent Literature 1, there is disclosed a brake shoe for a drum brake. In this brake shoe, a plurality of types of lining pieces different in friction coefficient μ are attached to a shoe body so that a relationship between a “contact angle θ2” and a “friction angle θ1=tan⁻ ¹1/μ” on a contact surface (friction surface) between a lining and a brake drum satisfies “θ₁≥θ₂” on an entire contact surface. In this case, the lining piece having a high friction coefficient is attached to a center portion of the brake shoe having a small contact angle θ₂, and a lining piece having a low friction coefficient is attached to vicinities of end portions, such as a toe portion, a heel portion, and the like, having a large contact angle θ₂.

### CITATION LIST

### Patent Literature

PTL 1: JP 08-210395 A

### SUMMARY OF INVENTION

### Technical Problem

In Patent Literature 1, in order to prevent occurrence of brake squeal, the plurality of types of lining pieces different in friction coefficient u are attached to the shoe body, but burnish of the lining is not considered. In a case of a drum brake of an internally-expanding type, in a state in which the burnish is not sufficient before bedding-in of the linings, a brake factor (BF) is low, and hence input higher than input required when the burnish is completed is required. Effectiveness of the brake is secured by the higher input, but when a time for the burnish is long, there is a fear in that variation of the brake factor may occur until the burnish is completed.

It is an object of the present invention to provide a drum brake and a braking member which reduce a time for burnish, thereby being capable of suppressing variation of brake factor from an initial stage of use.

### Solution to Problem

According to one embodiment of the present invention, there is provided a drum brake, including: a braking member configured to brake a drum rotor by being pressed against an inner peripheral surface of the drum rotor rotating together with a wheel, the braking member including: a first lining portion that is one end portion of a friction material in an arc shape opposing the inner peripheral surface of the drum rotor in a rotation direction of the drum rotor; a second lining portion that is another end portion of the friction material in the rotation direction of the drum rotor; and a third lining portion that is positioned between the one end portion and the another end portion in the rotation direction of the drum rotor, and is produced such that the third lining portion wears earlier than the first lining portion and the second lining portion; a back plate that is configured to support the braking member, and is fixed to a non-rotation portion of a vehicle; and an actuator unit configured to press the braking member against the inner peripheral surface of the drum rotor.

Further, according to one embodiment of the present invention, there is provided a braking member configured to brake a drum rotor by being pressed against an inner peripheral surface of the drum rotor rotating together with a wheel, the braking member including: a first lining portion that is one end portion of a friction material in an arc shape opposing the inner peripheral surface of the drum rotor in a rotation direction of the drum rotor; a second lining portion that is another end portion of the friction material in the rotation direction of the drum rotor; and a third lining portion that is positioned between the one end portion and the another end portion in the rotation direction of the drum rotor, and is produced such that the third lining portion wears earlier than the first lining portion and the second lining portion.

According to one embodiment of the present invention, the time for burnish is reduced, thereby being capable of suppressing the variation of the brake factor from the initial stage of use.

### BRIEF DESCRIPTION OF DRAWINGS

FIG. 1 is a front view for illustrating a drum brake according to a first embodiment of the present invention.

FIG. 2 is an enlarged view for illustrating a braking member (brake shoe) of FIG. 1 as a single part.

FIG. 3 is a side view of the braking member of FIG. 2 as viewed from the left side. FIG. 4 is a cross-sectional view of the braking member of FIG. 2 as viewed from an arrow IV-IV direction of FIG. 3.

FIG. 5 is a cross-sectional view of the braking member according to a second embodiment of the present invention as viewed in the same direction as that of FIG. 4.

FIG. 6 is a cross-sectional view of the braking member of FIG. 5 as viewed from an arrow VI-VI direction of FIG. 5.

FIG. 7 is a front view for illustrating a drum brake according to a third embodiment of the present invention.

FIG. 8 is an explanatory view for illustrating a lower half of the drum brake of FIG. 7 in a state in which a parking brake is operated.

### DESCRIPTION OF EMBODIMENTS

Description is now given of a case in which a drum brake and braking members according to embodiments of the present invention are mounted to a four-wheeled vehicle as an example with reference to the accompanying drawings.

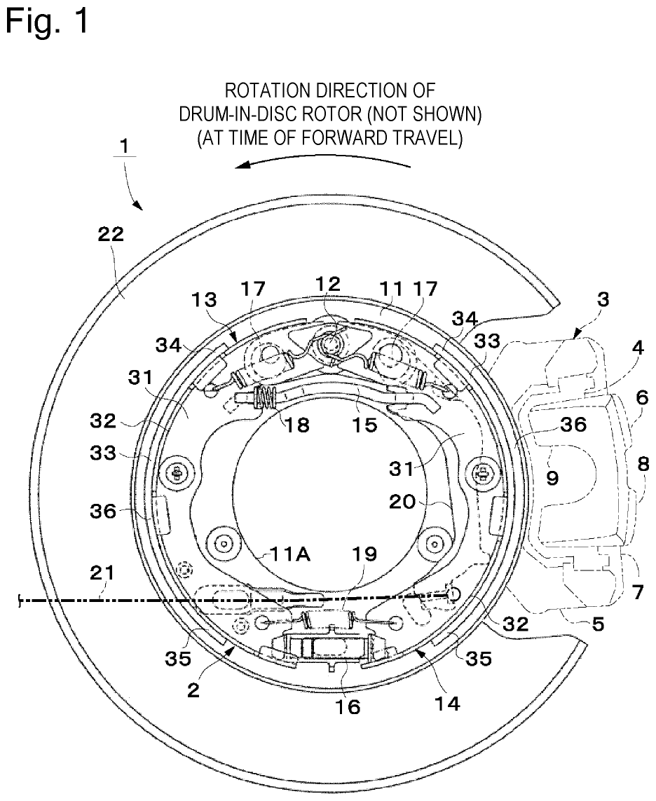

FIG. 1 to FIG. 4 show a first embodiment. In FIG. 1, a drum-in-disc brake device 1 is a disc brake 3 including a drum brake 2 for a parking brake. In other words, the drum-in- disc brake device 1 is a brake device integrally including the drum brake 2 and the disc brake 3.

The drum-in-disc brake device 1 is provided on, for example, a rear wheel side of the vehicle (motor vehicle) (not shown) and applies a braking force to the vehicle (for example, service brakes by the disc brakes 3 and parking brakes by the drum brakes 2). In this case, the drum-in-disc brake device 1 applies the braking force to the vehicle via a drum-in-disc rotor (not shown) serving as a braked member. The drum-in-disc rotor is mounted to, for example, a wheel hub unit (not shown) which rotatably supports the wheel (rear wheel), and rotates together with the wheel.

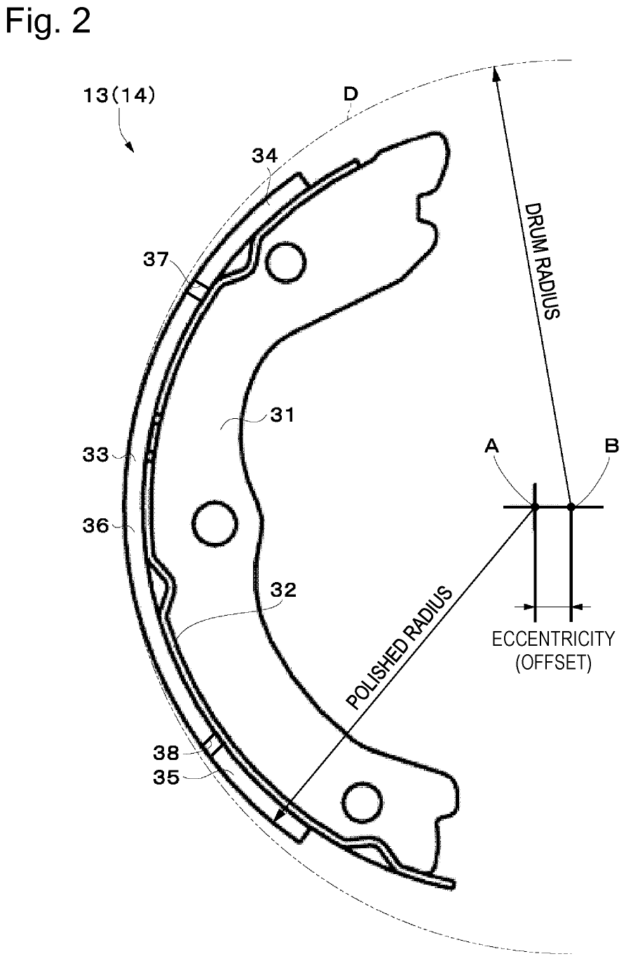

The drum-in-disc rotor is formed into, for example, a flanged cylindrical shape as a whole, and includes a disc rotor in an annular shape (disc shape) and a drum rotor D (see FIG. 2) in a cylindrical shape (drum shape) integrally provided on a radially inner side of the disc rotor. Braking members (brake pads 4) of the disc brake 3 are pressed against the disc rotor of the drum-in-disc rotor. Braking members (brake shoes 13 and 14) of the drum brake 2 are pressed against the drum rotor D of the drum-in-disc rotor. As a result, the braking force is applied to the wheel (for example, the rear wheel) rotating together with the drum-in-disc rotor, that is, the disc rotor and the drum rotor D.

The drum-in-disc brake device 1 includes the disc brake 3 arranged on an outer peripheral side of the drum-in-disc rotor and the drum brake 2 arranged on an inner peripheral side of the drum-in-disc rotor. The disc brake 3 is a brake mechanism of a hydraulic type which applies the braking force by pressing the pair of brake pads 4 (only one is shown) on both side surfaces of the disc rotor through a hydraulic pressure. The disc brake 3 includes, for example, a mounting member 5 referred to as a carrier, a caliper 6 serving as a wheel cylinder, the pair of brake pads 4 serving as braking members (friction members), and a piston (not shown) serving as a pressing member.

The mounting member 5 is fixed to a non-rotation portion of the vehicle, and is arranged across an outer peripheral side of the disc rotor. The caliper 6 is provided on the mounting member 5 such that the caliper 6 can move in an axial direction of the disc rotor. The caliper 6 is formed of a cylinder body portion 7 into and to which the piston is inserted and fit and a claw portion 9 connected to the cylinder body portion 7 through intermediation of a bridge portion 8. The brake pads 4 are movably mounted to the mounting member 5, and are arranged such that the brake pads 4 can abut against the disc rotor.

The piston presses the brake pad 4 against the disc rotor. The hydraulic pressure (brake fluid pressure) is supplied (applied) to the caliper 6 based on an operation on a brake pedal or the like. As a result, the pair of brake pads 4 are pressed against the both surfaces of the disc rotor by the piston and the claw portion 9 of the caliper 6, to thereby apply the braking force to the wheel (for example, the rear wheel) rotating together with the disc rotor.

The drum brake 2 is a brake mechanism of a cable type which applies the braking force by pressing the pair of brake shoes 13 and 14 against an inner peripheral surface of the drum rotor D through a brake cable 21. The drum brake 2 is formed as the drum brake for the parking brake of a duo-servo type (DS type). The drum brake 2 includes a back plate 11, an anchor 12, the primary brake shoe 13 (hereinafter also referred to as “primary shoe 13”), the secondary brake shoe 14 (hereinafter also referred to as “secondary shoe 14”), a strut 15, an adjuster 16, first springs 17, a second spring 18, a third spring 19, a lever 20, and the brake cable 21.

The back plate 11 is formed into a substantially annular shape, and is fixed to a non-rotation portion of the vehicle. The back plate 11 is mounted on a vehicle body side of the vehicle such that the back plate 11 covers an opening of the drum rotor D. The back plate 11 includes an insertion hole 11A which is formed at a center, and through which a wheel hub unit is inserted. On an outer peripheral side of the back plate 11, a disc cover 22 which protects the disc rotor of the drum-in-disc is provided.

On the back plate 11, the primary shoe 13 and the secondary shoe 14, each of which is the braking member, are arranged such that the primary shoe 13 and the secondary shoe 14 oppose each other. In this case, the primary shoe 13 and the secondary shoe 14 are each provided on the back plate 11 such that one end side (upper end side of FIG. 1) being a distal end portion can expand while another end side (lower end side of FIG. 1) being a base end side serves as fulcrum for turn. That is, the back plate 11 supports the primary shoe 13 and the secondary shoe 14. The anchor 12 is provided on one end side (upper end side of FIG. 1) of the back plate 11.

The one end side of the primary shoe 13 and the one end side of the secondary shoe 14 are supported by the anchor 12 such that the one end side of the primary shoe 13 and the one end side of the secondary shoe 14 can be apart from each other. The first springs 17 serving as return springs are provided between the one end side of the primary shoe 13 and the anchor 12 and between the one end side of the secondary shoe 14 and the anchor 12, respectively. The one end side of the primary shoe 13 and the one end side of the secondary shoe 14 are biased toward the anchor 12 side by the first springs 17.

Moreover, the strut 15 is provided between the one end side of the primary shoe 13 and the one end side of the secondary shoe 14. Both ends of the strut 15 are engaged with the one end side of the primary shoe 13 and the one end side of the secondary shoe 14. The second spring 18 is provided between one end (left end of FIG. 1) of the strut 15 and the primary shoe 13.

Meanwhile, the another end side of the primary shoe 13 and the another end side of the secondary shoe 14 are supported such that the primary shoe 13 and the secondary shoe 14 can swing by the adjuster 16 which can be adjusted so as to extend and contract. The adjuster 16 can adjust a gap between the another end side of the primary shoe 13 and the another end side of the secondary shoe 14. Moreover, the third spring 19 is provided between the another end side of the primary shoe 13 and the another end side of the secondary shoe 14. The another end side of the primary shoe 13 and the another end side of the secondary shoe 14 are biased by the third spring 19 such that the another end side of the primary shoe 13 and the another end side of the secondary shoe 14 approach each other.

The primary shoe 13 and the secondary shoe 14 brake the drum rotor D by being pressed against the inner peripheral surface of the drum rotor D. Each of the primary shoe 13 and the secondary shoe 14 includes a shoe web 31 and a shoe rim 32 which form a shoe body, and a friction material 33. The shoe web 31 is formed into a flat plate shape substantially parallel with a plate surface of the back plate 11, and the entire shoe web 31 curves into an arc shape. The shoe rim 32 is provided at an outer peripheral edge of the shoe web 31 in the arc shape. The entire shoe rim 32 is formed into a curved belt shape, and extends along the outer peripheral edge of the shoe web 31. The friction material 33 is formed into a curved plate shape, and is referred to as a lining or a brake lining. The friction material 33 is provided on an outer peripheral surface of the shoe rim 32 forming the shoe body. In this case, the friction material 33 is fixed to the outer peripheral surface of the shoe rim 32 through, for example, adhesive.

The lever 20 is provided between the back plate 11 and the secondary shoe 14. For example, one end side (upper end side of FIG. 1) of the lever 20 is pivotally supported by the secondary shoe 14. The brake cable 21 for pulling the lever 20 is coupled to another end side (lower end side of FIG. 1) of the lever 20. The brake cable 21 is connected to, for example, a parking lever provided in a vicinity of a driver seat of the vehicle or a parking pedal of a step-on type.

When the brake cable 21 is pulled leftward of FIG. 1 by operating the parking lever or the parking pedal, the lever 20 axially supported by the secondary shoe 14 turns, to thereby push out the strut 15 sandwiched between the secondary shoe 14 and the primary shoe 13. As a result, the primary shoe 13 and the secondary shoe 14 expand to press the outer peripheral surface of the friction material 33 of the primary shoe 13 and the outer peripheral surface of the friction material 33 of the secondary shoe 14 against the inner peripheral surface of the drum rotor D, to thereby apply the braking force.

The lever 20 corresponds to an actuator unit which presses the primary shoe 13 and the secondary shoe 14 against the inner peripheral surface of the drum rotor D. The lever 20 is connected to a parking operation unit (parking lever or parking pedal) having a ratchet mechanism through intermediation of the brake cable 21. The ratchet mechanism can hold the pulled brake cable 21. As a result, the lever 20 includes a parking brake mechanism that holds the braking force. The parking brake mechanism is of the duo-servo type (DS type), and operates the primary shoe 13 and the secondary shoe 14 of the drum brake 2.

Incidentally, in the case of the drum brake of the internally-expanding type including a shoe expansion device which expands the pair of brake shoes, the brake factor (BF) is small before bedding-in of the brake shoes, that is, burnish of the linings (friction materials) on the drum rotor is insufficient. As a result, when the burnish is insufficient, it is required to secure effectiveness of the brake by inputting an operation force (input) sufficiently larger than an operation force required in a state in which the burnish is completed. In particular, in the drum brake of the duo-servo type (DS type) which can achieve a large brake factor in the sufficiently burnished state, a change in brake factor is large between before and after the burnish. Thus, when such a drum brake of the duo-servo type is employed, a large operation force is required to obtain predetermined parking brake performance (braking force) in a completion inspection immediately after vehicle assembly.

In more details, in the case of the drum brake, self-lock may occur, that is, the end portions of the linings on a side in which the linings rotationally enter the drum may first come in contact with the drum to lock themselves before the bedding-in (before the burnish). In order to avoid the self-lock, for example, as illustrated in FIG. 2 described later, it is conceivable to apply offset polishing to a lining outer diameter portion so that the burnish gradually occurs from a vicinity of a center of a stretch angle of the lining. However, in this case, that is, in the case of a drum brake including the pair of linings having the offset-polished outer diameter portions, in the state of the insufficient burnish immediately after the vehicle assembly, the brake factor is small, and hence it is difficult to secure sufficient effectiveness of the brake.

The brake factor increases as the burnish progresses. Thus, it is required to determine the size of the drum brake and the material of the linings to avoid excessive effect even in the state in which the burnish is sufficiently achieved. Meanwhile, in a brake effectiveness inspection executed immediately after the vehicle assembly, it is required to exert a predetermined braking force (parking brake performance and the like). At this time, a large operation force is required to compensate the small brake factor. When the parking brake is manually operated, the brake factor increases as the burnish caused by the use progresses, and hence the operation force (input) can gradually be reduced. Meanwhile, for example, consideration is given of a case in which the parking brake is electrically operated. In this case, in response to the progress situation of the burnish (state of the effectiveness of the brake), a control program which has a large number of sensing functions and applies a complicated operation force based thereon is required so as to reduce the operation force (input). That is, in the case of the electric parking brake, in order to accurately reflect the state of the burnish (state of the effectiveness of the brake) to the operation force (input), the complicated sensing function and the control of the operation force based thereon are required.

Moreover, in the case of the electric parking brake, an electric drive device which has, as regular-use output, a large operation force required at an initial stage of use is required. In other words, in the case of the electric parking brake, it is required to use an electric drive device having high output based on the output (large operation force) required at the initial stage of use as a criterion. Moreover, it is required to employ a strong drum brake so that durability of the drum brake is secured even when the large operation force is output. However, a vehicle employing the drum brakes is a vehicle of an inexpensive type, a vehicle of a popular type, or a small vehicle, and hence a low cost, a low weight, and space saving are required.

Consideration is now given of the bedding-in (burnish) of the drum brake in a vehicle assembly process. In this case, it is required to execute bedding-in process a plurality of different times between, for example, the assembly of the vehicle and the completion inspection process for inspecting the braking force in order to obtain an appropriate burnished state while avoiding an excessive temperature increase of the linings. Accordingly, it is preferred that a time for the bedding-in, that is, a time for the burnish be reduced also in terms of a reduction in the bedding-in process.

Moreover, when the drum brake is operated as the service brake, it is required to increase a set value of a TSCC (total shoe center clearance) provided by an automatic adjuster mechanism of a service brake operation type which operates in accordance with movement amounts of the shoes at the time of the service brake operation. That is, the set value for the TSCC is required to be a large value so that the automatic adjuster mechanism does not execute over adjustment even when the brake is operated in a low stiffness state in which the burnish is insufficient (state in which the movement amounts of the shoes are large). As a result, a pedal operation amount becomes large, which may lead to a decrease in pedal feeling and a decrease in responsiveness at a time of operations of automatic hold and automatic release.

In any case, when the time for the burnish for the brake shoes is reduced, thereby being capable of suppressing the variation of the brake factor from the initial stage of use, it is possible to reduce the operation force required to obtain the required braking force from the initial stage of use. As a result, the operation force for the drum brake can be reduced in, for example, a brake effectiveness inspection immediately after the vehicle assembly. Moreover, the number of times of the bedding-in process (work for obtaining an appropriate burnished state) after the vehicle assembly and before the completion inspection process for inspecting the braking force. As a result, even when a size of the drum brake and a material of the linings which are not excessively effective even in the state of the sufficient burnish are employed, the operation force in the brake effectiveness inspection immediately after the vehicle assembly can be reduced. Further, in the case of the electric parking brake, in addition to elimination of the complex sensing function and the control of accurately reflecting the state of the burnish to the operation force, the output performance of the electric drive device can be reduced. As a result, the reduction in size of the drum brake, the reduction in space, a reduction in weight, and the reduction in cost can be achieved.

Thus, in this embodiment, the following configuration is employed to reduce the time for the burnish of the brake shoes (linings), thereby being capable of suppressing the variation of the brake factor from the initial stage of use. That is, the primary shoe 13 and the secondary shoe 14 are formed of the friction materials 33. As illustrated in FIG. 2, a center A of an outer diameter of the friction material 33 is offset (eccentric) with respect to a center B of an inner diameter of the drum brake. In addition to this configuration, friction characteristic is different between a vicinity of a center of the friction material 33 and both end sides thereof such that a lining portion in the vicinity of the center of a stretch angle of the friction material 33 (third lining portion) wears earlier than lining portions on the both end sides (a first lining portion and a second lining portion).

In this case, a wear rate (wear amount per unit slip distance) in the vicinity of the center of the friction material 33 is set to be larger than wear rates on the both end sides. More specifically, the vicinity of the center of the friction material 33 has a large wear rate than those of the both end sides of the friction material 33 at least at the initial stage. The friction material 33 of the primary shoe 13 and the friction material 33 of the secondary shoe 14 have the same configuration, and hence description is hereinafter mainly given of the friction material 33 of the primary shoe 13 with reference to FIG. 2 to FIG. 4 in addition to FIG. 1.

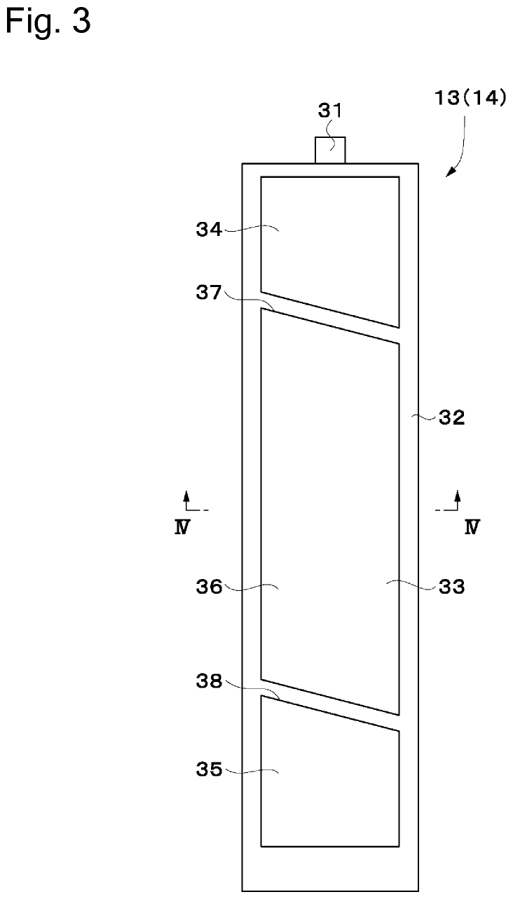

As illustrated in FIG. 2 and FIG. 3, the friction material 33 includes a first lining material 34 being a first lining portion, a second lining material 35 being a second lining portion. and a third lining material 36 being a third lining portion. In this embodiment, the friction material 33 is formed of the three individual (independent) lining materials 34, 35, and 36. However, the configuration is not limited to this example, and. for example. the friction material may be formed of one lining material, that is, one lining material formed by integrating the first lining portion, the second lining portion, and the third lining portion.

The first lining material 34 is one end portion (for example, an upper end portion of FIG. 1 to FIG. 3) of the friction material 33 in an arc shape opposing the inner peripheral surface of the drum rotor D in the rotation direction of the drum rotor D. The second lining material 35 is another end portion (for example, a lower end portion of Fig. I to FIG. 3) of the friction material 33 in the rotation direction of the drum rotor D. The third lining material 36 is positioned between the one end portion and the another end portion (for example, an intermediate portion of Fig. I to FIG. 3) in the rotation direction of the drum rotor D. The third lining material 36 is produced such that the third lining material 36 wears earlier than the first lining material 34 and the second lining material 35.

In the first embodiment, at least one of the following configurations (A) and (B) is employed so that the third lining material 36 wears earlier than the first lining material 34 and the second lining material 35. With this configuration, the wear rate of the third lining material 36 at least at the initial stage is set to be higher than the wear rates of the first lining material 34 and the second lining material 35. (A) The third lining material 36 is different in mixing component or mixing ratio of a material from the first lining material 34 and the second lining material 35. (B) A porosity in the third lining material 36 is higher than porosities in the first lining material 34 and the second lining material 35.

In the case of (B), the porosity of the third lining material 36 can be increased by, for example, reducing a compression pressure at a time of molding. Moreover, for example. a porosity in a vicinity of the outer peripheral surface can be increased by applying scorching (heating treatment) to the third lining material 36. In this case, that is, the case in which the wear rate is increased through the scorching (heating treatment), the promotion of the wear can be easily facilitated by limiting the processing to a range of a surface portion. that is, a thickness required for the burnish. In any case, the mixing component or the mixing ratio of the material and the porosities (compression pressure and heating treatment) of the lining members 34, 35, and 36 can be set such that the third lining material 36 wears earlier. That is. the mixing component or the mixing ratio of the material and the porosities (compression pressure and heating treatment) can be set such that the time for the burnish is reduced, thereby being capable of suppressing the variation of the brake factor from the initial stage of use.

As described above, in the first embodiment, the vicinity of the center of the stretch angle of the offset-polished friction material 33 (third lining material 36) wears earlier than the vicinities of the both ends (first lining material 34 and the second lining material 35) of the friction material 33. Thus, sufficient burnish can be achieved over a wide range of a sliding surface of the friction material 33 from the initial stage of use of the drum brake 2, thereby being capable of obtaining a high braking force. Moreover, the time for the bedding-in executed after the vehicle assembly can be reduced or omitted. Thus, even for a drum brake in which the wear (burnish) is less liable to progress in a normal use such as the drum brake 2 of the duo-servo type (DS type) for the parking brake used in combination with the disc brake 3, the time for the bedding-in executed after the vehicle assembly can be reduced or omitted.

Moreover, a high braking force can stably be obtained in a period from the initial stage of use to a time of replacement of the friction material 33. Thus, when the parking pedal or the parking brake lever in the vicinity of a driver seat is operated to operate the lever 20 serving as the actuator for the drum brake 2, a small operation force is required, and hence good operation feeling can be obtained. Moreover, for example, also when the configuration of electrically operating the parking brake is employed. that is. when an electric actuator is used to apply the braking force (parking brake), the initial ineffectiveness can be suppressed. As a result, in addition to securing durability of the drum brake 2, the reduction in size and the reduction in weight can be achieved.

Further, the sufficient burnish is achieved in a wide range of the sliding surface (friction surface or sliding surface) of the friction material 33 from the initial stage of use. and hence a stroke of the actuator (lever 20) used for deflection of the brake shoes 13 and 14 at the time of the operation of the drum brake 2 is reduced, with the result that high rigidity can be obtained. Moreover, the high rigidity can stably be achieved for small input to large input in a period from the initial stage of use to the time of replacement of the friction material 33, and hence the set value of the TSCC through the automatic adjuster mechanism can be set small. As a result, also in this respect. the ineffective stroke of the actuator (lever 20) can be reduced. As a result. when the actuator (lever 20) is operated through the parking pedal or the parking lever in the vicinity of the driver seat. the good operation feeling can be obtained. Moreover, for example, when the electric actuator is used, the responsiveness increases, and hence an increase in output through a reduction in a speed reduction ratio, the reduction in size, and the reduction in weight can be achieved.

Moreover. in the first embodiment, the first lining material 34 and the third lining material 36 has a predetermined first gap portion 37 therebetween. The second lining material 35 and the third lining material 36 also has a predetermined second gap portion 38 therebetween. That is. the friction material 33 is divided into the three portions in the circumferential direction, and the gaps are provided at borders between the lining materials 34, 35, and 36. As a result, the gap portions 37 and 38 being grooves are provided at the borders between the lining materials 34, 35, and 36. In the first embodiment, the first gap portion 37 and the second gap portion 38 have the same shape. more specifically, have straight line shapes having the same width and have the same inclination angles with respect to the rotation direction of the drum rotor D.

However, the configuration is not limited to this example, and, for example, the first gap portion 37 and the second gap portion 38 may have different shapes. That is. the first gap portion 37 may have a shape different from the shape of the second gap portion 38 as viewed from the side of the inner peripheral surface of the drum rotor D. In this case, for example, the widths of the gaps (grooves) of the first gap portion 37 and the second gap portion 38 can be different from each other. Moreover, the angle of the first gap portion 37 and the angle of the second gap portion 38. that is. the inclination angles with respect to the rotation direction of the drum rotor D as viewed from the outer peripheral surface side of the friction material 33 may be different from each other. Further, as shapes of the first gap portion 37 and the second gap portion 38, for example, one thereof may be any one of a straight line. a polygonal line, or a curved line, and another thereof may be a straight line. a polygonal line, or a curved line different from the one thereof.

In any case, in the first embodiment, the friction material 33 is divided into the three portions in the rotation direction of the drum rotor D, and the three lining materials 34, 35, and 36 are attached to the outer peripheral surface of the shoe rim 32. Moreover, at the borders between the lining materials 34, 35, and 36, that is, the border between the first lining material 34 and the third lining material 36 and the border between the second lining material 35 and the third lining material 36, the gap portions 37 and 38 being the grooves inclined with respect to the rotation direction of the drum rotor D are formed.

The first gap portion 37 and the second gap portion 38 can be used as gaps for water drainage. That is, when water infiltrates between the drum rotor D and the sliding surface of the friction material 33 as a result of passage over a puddle or the like, this water can be drained via the first gap portion 37 and the second gap portion 38. As a result, water drainage capability can be increased, and hence recovery capability from the water fade can be increased. Further, when the first gap portion 37 and the second gap portion 38 have different shapes, the attachment positions of the lining materials 34. 35, and 36 can be restricted. As a result, when the lining materials 34, 35, and 36 are assembled to the outer peripheral surface of the shoe rim 32. it is possible to suppress assembly of an erroneous lining material (erroneous assembly). For example, it is possible to prevent erroneous assembly through use of a positioning jig at the time of the assembly by setting the width and the inclination angle of the first gap portion 37 to be larger than the width and the inclination angle of the second gap portion 38.

Moreover, although not shown. the friction material may be formed of one lining material, that is, one lining material formed by integrating the first lining portion, the second lining portion, and the third lining portion. In this case, for example, the wear rate of the third lining portion can be set larger than the wear rates of the second lining portion and the third lining portion by applying the scorching (heating treatment) to the third lining portion. As described above. when the friction material is formed of one lining material. the assembly work for the friction material can be easily performed. Moreover, the state of the burnish of the third lining portion can be adjusted without changing the lining material.

The drum-in-disc brake device I according to this embodiment has the above-mentioned configuration. Description is now given of an operation thereof.

For example, when a driver of the vehicle executes a depression operation on the brake pedal, the hydraulic pressure (brake hydraulic pressure) is supplied (applied) to the caliper 6 of the disc brake 3. and hence the braking force (service brake) is applied to the wheel. At this time, the piston slidingly displaces toward the brake pad 4 as the brake hydraulic pressure in the caliper 6 increases, and the pair of the brake pads 4 are pressed against the both surfaces of the disc rotor by the piston and the claw portion 9 of the caliper 6. As a result, the braking force based on the brake hydraulic pressure is applied. Meanwhile, when the brake operation is cancelled, the piston displaces such that the piston separates from the disc rotor as a result of cancellation of the supply of the brake hydraulic pressure to the inside of the caliper 6. As a result. the brake pads 4 separate from the disc rotor, and the vehicle is brought back into a non-braking state.

After that, when the driver of the vehicle operates the parking brake lever or the parking pedal, the brake cable 21 connected to the lever 20 of the drum brake 2 is pulled leftward of FIG. 1. With this, the lever 20 axially supported by the secondary shoe 14 pushes out the strut 15 while turning, to thereby expand the primary shoe 13 and the secondary shoe 14. As a result. the outer peripheral surface of the friction material 33 of the primary shoe 13 and the outer peripheral surface of the friction material 33 of the secondary shoe 14 are pressed against the inner peripheral surface of the drum rotor D. to thereby apply the braking force. This braking force (parking brake) is maintained by a ratchet mechanism provided to the parking lever or the parking pedal. When the braking force (parking brake) is to be released, the parking lever or the parking pedal is returned by releasing engagement of the ratchet mechanism. As a result, the lever 20 is returned, and hence the friction material 33 of the primary shoe 13 and the friction material 33 of the secondary shoe 14 separate from the drum rotor D.

In the first embodiment, each of the friction material 33 of the primary shoe 13 and the friction material 33 of the secondary shoe 14 includes the first lining portion (first lining material 34) being the one end portion in the rotation direction of the drum rotor D. the second lining portion (second lining material 35) being the another end portion, and the third lining portion (third lining material 36) positioned between the one end portion and the another end portion. Moreover, the third lining portion (third lining material 36) is produced such that the third lining portion wears earlier than the first lining portion (first lining material 34) and the second lining portion (second lining material 35). Thus, when the primary shoe 13 and the secondary shoe 14 are burnished on the drum rotor D. the wear of the third lining portions (third lining materials 36) becomes earlier, and hence the time for the burnish can be reduced. As a result, the variation of the brake factor can be suppressed from the initial stage of use.

In the first embodiment, the first lining portion, the second lining portion, and the third lining portion are the individual first lining material 34. second lining material 35, and third lining material 36, respectively. In other words, the friction material 33 is divided into at least the three lining materials of the first lining material 34, the second lining material 35. and the third lining material 36. Moreover, the first lining material 34 and the third lining material 36 has the first gap portion 37 therebetween, and the second lining material 35 and the third lining material 36 has the second gap portion 38 therebetween. The first gap portion 37 and the second gap portion 38 can be used as the gaps for the water drainage.

In the case in which the first gap portion 37 and the second gap portion 38 have shapes different from each other, assembly of erroneous lining materials 34, 35, and 36 (erroneous assembly) can be suppressed when the lining materials 34, 35. and 36 are assembled to the outer peripheral surface of the shoe rim 32.

In the first embodiment, the third lining portion (third lining material 36) is different in mixing component or mixing ratio of the material from the first lining portion (first lining material 34) and the second lining portion (second lining material 35). Thus, promotion of the wear of the third lining portion (third lining material 36) can be facilitated by differentiating the mixing component or the mixing ratio of the material.

In the first embodiment, the porosity in the third lining portion (third lining material 36) is higher than the porosities in the first lining portion (first lining material 34) and the second lining portion (second lining material 35). Thus. a density of the third lining portion (third lining material 36) can be set low, and hence the promotion of the wear of the third lining portion (third lining material 36) can be facilitated.

In the first embodiment, the lever 20 serving as the actuator unit is connected to the parking operation unit (parking lever or parking pedal) having the ratchet mechanism through intermediation of the brake cable 21. As a result, the lever 20 includes the parking brake mechanism that holds the braking force. Thus, the time for the burnish of the drum brake 2 used as the parking brake can be reduced.

In the first embodiment, the drum brake 2 including the parking brake mechanism (the lever 20, the brake cable 21, and the ratchet mechanism) operates as the duo-server type (DS type). Thus, the time for the burnish of the drum brake 2 used as the parking brake of the duo-servo type can be reduced.

In the first embodiment, the case in which the drum brake 2 is configured as the parking brake of the duo-servo type is described as an example. However, the configuration is not limited to this example, and the drum brake may be configured as, for example, a service brake of a leading trailing type (LT type) which expands one end sides of a pair of brake shoes by an actuator unit fixed to a back plate. In this case, the actuator unit can be formed of, for example, a wheel cylinder to which the hydraulic pressure (brake hydraulic pressure) is supplied based on the operation of the brake pedal or the like. Moreover, the drum brake may be configured as an electric drum brake by using an electric actuator driven by an electric motor as the actuator unit.

Description is now given of an increase in recovery capability from the water fade given as a performance requirement for the service brake as described above. The first lining material 34 and the third lining material 36 has the first gap portion 37 therebetween, and the second lining material 35 and the third lining material 36 has the second gap portion 38 therebetween. The first gap portion 37 and the second gap portion 38 can be used as the gaps for the water drainage. That is, when the water infiltrates between the drum rotor D and the primary shoe 13 and the secondary shoe 14 as a result of passage over a puddle or the like, this water can be drained via the first gap portion 37 and the second gap portion 38. As a result, the water drainage capability can be increased, and hence the recovery capability from the water fade can be increased.

Moreover, the drum brake can be configured to include, for example, the automatic adjuster mechanism of a service brake operation type which operates in accordance with an increase in movement amounts of the brake shoes at the time of the service brake operation. Moreover, the drum brake may be configured to include, for example, a temperature compensation mechanism through bimetal which stops the operation of the automatic adjuster while the drum rotor D is thermally expanded due to heat generation caused by the braking.

Moreover, the drum brake can be configured, for example. to include a parking brake mechanism which operates to expand a pair of brake shoes when a parking brake is operated by an actuator unit sandwiched between one end sides of the both brake shoes. In this case, the drum brake can be configured, for example, to operate as the duo-servo type (DS type) at the time of the parking brake operation. The drum brake may be configured as an electric parking drum brake by using an electric actuator driven by an electric motor as the actuator unit. The electric actuator may be formed of only an electric motor (rotation motor or linear motor) or an electric motor and a speed reducer.

As described above, according to the first embodiment. as illustrated in FIG. 2. the outer periphery of the friction materials 33 forming the brake shoes 13 and 14 are offset-polished. Thus. when the operation force is input via the lever 20 at the braking time, the vicinities of the centers of the friction materials 33 first come in contact with the drum rotor D, and when the input further increases. ranges of contact surfaces of the friction materials 33 extend to the both end sides as a result of the deflection of the brake shoes 13 and 14. While the burnish of the friction materials 33 on the drum rotor D is insufficient, the brake is ineffective by an amount corresponding to a force and a stroke for deflecting the brake shoes 13 and 14. However, in the first embodiment, the promotion of the wear of the vicinity of the center of the friction material 33 (the third lining material 36) is facilitated by, for example. increasing the porosity of this portion. As a result, the time for the burnish can be reduced. Meanwhile, the porosities on the both end sides (first lining material 34 and second lining material 35) of the friction material 33 are low, and hence the friction material 33 can withstand a high load.

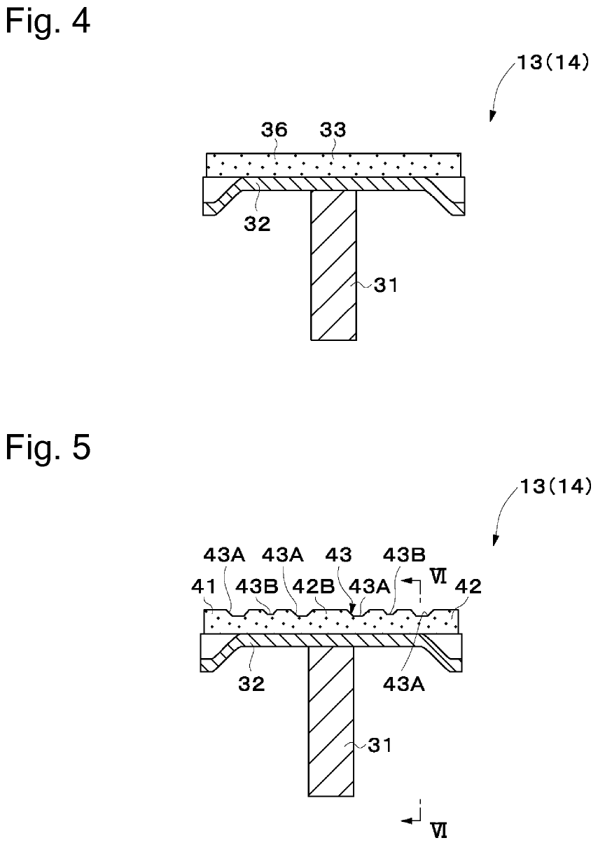

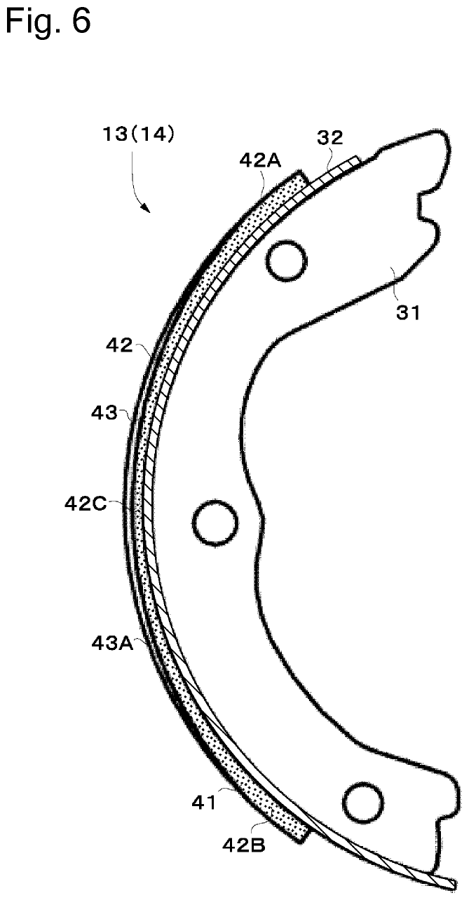

FIG. 5 and FIG. 6 show a second embodiment. A feature of the second embodiment is that a groove portion is provided on the outer peripheral surface of the third lining portion. In the second embodiment, the same components as those of the first embodiment described above are denoted by the same reference symbols, and description thereof is omitted.

Also in the second embodiment, as in the first embodiment, the brake shoes 13 and 14 include friction materials 41. In the first embodiment described above, the first lining portion, the second lining portion. and the third lining portion of the friction material 33 are formed of the individual first lining material 34, second lining material 35, and third lining material 36, respectively. Meanwhile, in the second embodiment, the friction material 41 is formed of one lining material 42, that is, one lining material 42 integrally formed of a first lining portion 42A, a second lining portion 42B, and a third lining portion 42C.

The first lining portion 42A is one end portion (for example, an upper end portion of FIG. 6) of the friction material 41 in an arc shape opposing the inner peripheral surface of the drum rotor D in the rotation direction of the drum rotor D. The second lining portion 42B is another end portion (for example, a lower end portion of FIG. 6) of the friction material 41 in the rotation direction of the drum rotor D. The third lining portion 42C is positioned between the one end portion and the another end portion (for example, an intermediate portion of FIG. 6) in the rotation direction of the drum rotor D. The third lining portion 42C is produced such that the third lining portion 42C wears earlier than the first lining portion 42A and the second lining portion 42B.

In the second embodiment, at least one of the following configurations (A) to (C) is employed so that the third lining portion 42C wears earlier than the first lining portion 42A and the second lining portion 42B. With this configuration, the wear rate of the third lining portion 42C at least at the initial stage is higher than the wear rates of the first lining portion 42A and the second lining portion 42B. (A) The third lining portion 42C is different in mixing component or mixing ratio of a material from the first lining portion 42A and the second lining portion 42B. (B) A porosity in the third lining portion 42C is higher than porosities in the first lining portion 42A and the second lining portion 42B. (C) A groove portion 43 is provided on the outer peripheral surface of the third lining portion 42C.

In the case of (C), the groove portion 43 may be a single groove or may be a configuration including a plurality of grooves 43A and 43B. In the second embodiment, as illustrated in FIG. 5, the groove portion 43 includes the plurality of grooves 43A and 43B. A contact area (width of a contact portion) with the drum rotor D at the braking time can be reduced by providing the groove portion 43 (grooves 43A and 43B), and hence a progress of the wear in the portion with the groove portion 43 (third lining portion 42C) can be earlier.

Further, the groove portion 43 has a groove width in a depth direction gradually decreasing from the outer peripheral surface of the third lining portion 42C toward the direction of the rotation center of the drum rotor D. That is, as illustrated in FIG. 5, a groove width in the depth direction of each of the plurality of grooves 43A and 43B forming the groove portion 43 gradually decreases toward the direction of the rotation center of the drum rotor D. In this case. a cross-sectional shape of each of the grooves 43A and 43B is such a trapezoidal shape that a width dimension decreases toward the shoe rim 32 side. However, the cross-sectional shape is not limited to this example, and may be, for example. a V shape. In any case. as a result of inclination of side surfaces of the grooves 43A and 43B, the contact area with the drum rotor D gradually increases as the wear of the friction material 41 (third lining portion 42C) progresses.

Moreover, the plurality of the grooves 43A and 43B may be different from one another in the depth and the groove width in the grooves 43A and 43B. In the second embodiment, the two types of groove 43A and 43B are provided to the outer peripheral surface of the friction material 41. The large groove 43A is larger in the depth dimension and the width dimension, and the small groove 43B is smaller in the depth dimension and the width dimension. The depth and the groove width of each of the grooves 43A and 43B is set such that the contact area with the drum rotor D successively increases as the friction material 41 wears. That is, a configuration (the number of grooves, the widths of the grooves, the depths of grooves, and the like) of the groove portion 43 is set such that the variation of the brake factor can be suppressed from the initial stage of use by reducing the time for the burnish.

Moreover. as illustrated in FIG. 6. in the second embodiment. a radius of a groove bottom as the brake shoes 13 and 14 are viewed in an axle direction is longer than a radius (polished radius) of the outer peripheral surface of the friction material 41. That is, the depth of each of the grooves 43A and 43B is deepest in the center portion (third lining portion 42C) of the stretch angle of the friction material 41, and gradually decreases toward the both ends (first lining portion 42A and second lining portion 42B) of the friction material 41. Thus, the contact area of the friction material 41 with the drum rotor D gradually increases from the center toward the both ends.

A depth of the deepest portions of the shallowest groove 43B of the grooves 43A and 43B can be. for example, 0.5 mm or less, and a depth of the deepest portion of the deepest groove 43A can be, for example, 1 mm or less. As a result, early wear of the outer peripheral surface of the friction material 41 (third lining portion 42C) after the sufficient burnish can be suppressed. Each of the grooves 43A and 43B may be formed such that the groove bottom forms a straight line as the brake shoes 13 and 14 are viewed from the axle direction.

The second embodiment presses the above-mentioned friction materials 41 against the drum rotor D, and a basic action thereof is not particularly different from that in the first embodiment. That is, the second embodiment can also reduce the time for the burnish, thereby being capable of suppressing the variation of the brake factor from the initial stage of use.

In particular, in the second embodiment, the groove portion 43 including the plurality of grooves 43A and 43B on the outer peripheral surface of the third lining portion 42C is provided. The number of groove portions 43 may be one or two or more, and, moreover, the groove portion 43 may be formed of one groove, or may be formed of the plurality of grooves 43A and 43B. In any case, the contact area (width of the contact portion) with the drum rotor D at the braking time can be reduced by providing the groove portion 43. As a result, the promotion of the wear of the third lining portion 42C can be facilitated.

In this case, a range in which the promotion of the wear is facilitated can be restricted by, for example, adjusting a position for providing the groove portion 43 and a depth thereof. Thus, even when the first lining portion 42A, the second lining portion 42B, and the third lining portion 42C are formed of. for example, one lining material, the promotion of the wear of the third lining portion 42C can be facilitated by providing the groove portion 43 in the portion corresponding to the third lining portion 42C. Moreover, a period in which the promotion of the wear is facilitated can be adjusted in accordance with the depth of the groove portion 43. Thus, for example, the promotion of the wear can be facilitated at only the initial stage of use by reducing the depths in the groove portion 43.

It is only required to provide the groove portion 43 on the outer peripheral surface of at least the third lining portion 42C. The groove portion 43 may be provided from the outer peripheral surface of the third lining portion 42C to the outer peripheral surface of the first lining portion 42A and/or the outer peripheral surface of the second lining portion 42B as long as the time for the burnish is reduced, thereby being capable of suppressing the variation of the brake factor from the initial stage of use. In other words, the groove portion 43 may be provided on the outer peripheral surface of the first lining portion 42A and/or the outer peripheral surface of the second lining portion 42B as long as the wear of the third lining portion 42C is promoted more than the wear of the first lining portion 42A and the second lining portion 42B. Moreover, the groove portion may not be provided on the outer peripheral surface of the first lining portion 42A and the outer peripheral surface of the second lining portion 42B, and the groove portion 43 may be provide only on the outer peripheral surface of the third lining portion 42C.

According to the second embodiment, the groove portion 43 has the groove width in the depth direction gradually decreasing from the outer peripheral surface of the third lining portion 42C toward the direction of the rotation center of the drum rotor D. Thus, the contact area of the third lining portion 42C increases due to the groove width decreasing as the wear progresses. As a result, the promotion of the wear of the third lining portion 42C at the initial stage of use can be facilitated. As a result, “the reduction in the time for the burnish” and “the securing durability (life until replacement) of the friction material 41” can simultaneously be achieved at a high level.

According to the second embodiment, the plurality of grooves 43A and 43B forming the groove portion 43 are different from each other in depth and groove width. Thus, the promotion of the wear of the third lining portion 42C can be facilitated by differentiating the depths and the groove widths (for example. the widths in the depth direction, the widths in the circumferential direction, the widths in the radial direction, and the like) of the plurality of grooves 43A and 43B.

In the second embodiment, description is given of the example case in which the friction material 41 is formed of one lining material 42. However, the configuration is not limited to this example, and, for example, the friction material may be formed of individual lining materials, that is. a first lining material corresponding to the first lining portion, a second lining material corresponding to the second lining portion, and a third lining material corresponding to the third lining portion as in the above-mentioned first embodiment. In this case, the groove portion can be provided on an outer peripheral surface of the third lining material.

Moreover. the groove portion can have the groove width in the depth direction gradually decreasing from the outer peripheral surface of the third lining material toward the direction of the rotation center of the drum rotor D. The number of groove portions may be one or two or more. and the groove portion may be formed of a single groove or may be a configuration including a plurality of grooves. When the groove portion is formed of a plurality of grooves. the depths and the groove widths in the grooves may be the same or different. The configuration (the number of grooves. the widths of the grooves, the depths of grooves, and the like) of the groove portion is set such that the variation of the brake factor can be suppressed from the initial stage of use by reducing the time for the burnish.

As described above, in the second embodiment, the wear rate of the third lining portion 42C corresponding to the vicinity of the center of the friction material 41 is set to high. In this case, the wear rate of the third lining portion 42C is set to high by providing the groove portion 43 in the outer peripheral surface of the third lining portion 42C. Moreover, the wear rate of the third lining portion 42C may be set to high by applying the scorching (heating treatment) to the third lining portion 42C, to thereby increase a porosity of a vicinity of the outer peripheral surface of the third lining portion 42C. In any case, the friction material 41 is formed of one lining material in addition to the facilitation of the promotion of the wear in the vicinity of the center of the friction material 41, and hence the assembly work of the lining material (friction material 41) can be made easy. Moreover, the state of the burnish of the third lining portion 42C can be adjusted without changing the lining material (friction material 41).

Moreover, the case in which the wear rate is increased by providing the groove portion 43 in the friction material 41 or applying the scorching (heating treatment), the promotion of the wear can be facilitated while limiting the provision of the groove portion 43 or the scorching to a surface portion, that is, a range of thickness required for the burnish. Further, when the groove portion 43 is provided in the friction material 41. a contact area of a portion in a vicinity of the anchor on an exit side in the rotation direction of the drum rotor D can be secured by limiting the portion in which the groove portion 43 is provided to the vicinity of the center of the friction material 41. As a result, the braking force can be secured even at a time of, for example, dynamic parking braking, which bears a high load. that is, when the braking is executed by using the drum brake 2 for the parking brake during the travel.

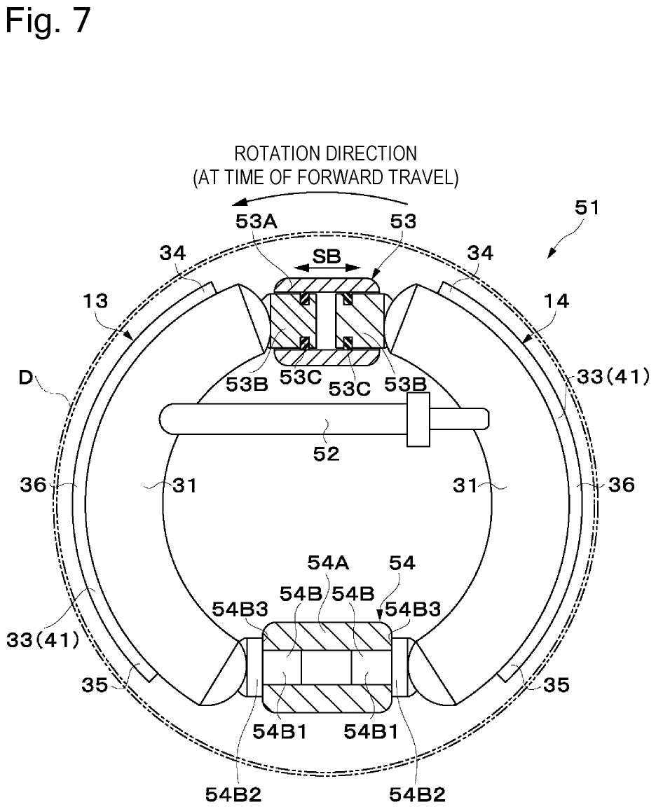

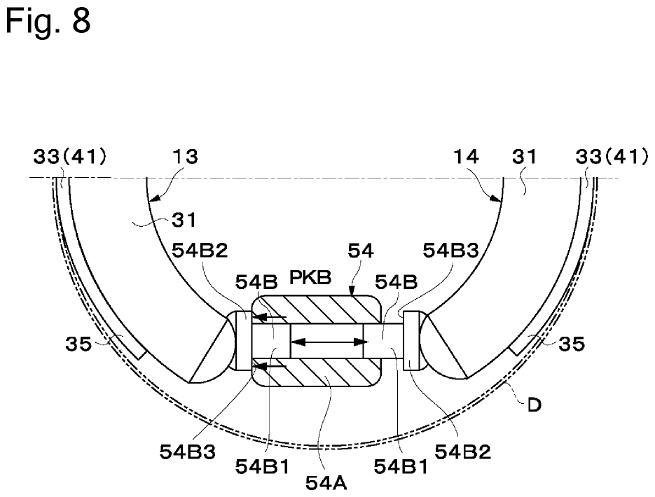

FIG. 7 and FIG. 8 show a third embodiment. A feature of the third embodiment is that a drum brake includes a wheel cylinder operated through a hydraulic pressure and a parking brake mechanism operated through an electric motor provided on a back plate. In the third embodiment, the same components as those of the first embodiment described above are denoted by the same reference symbols, and description thereof is omitted.

In the above-mentioned first embodiment, the drum brake 2 forms, together with the disc brake 3. the drum-in-disc brake device 1. Moreover, the drum brake 2 according to the first embodiment is the drum brake for the parking brake of the duo-servo type (DS type). Meanwhile, in the third embodiment. a drum brake 51 is a drum brake for a service brake of the leading trailing type (LT type), and is also a drum brake for a parking brake of the duo- servo type (DS type). Moreover, the drum brake 51 is an electric parking drum brake which electrically operates the parking brake. That is, in the third embodiment. the drum brake 51 operates as the leading trailing type (LT type) through the hydraulic pressure (wheel cylinder 53) at the time of the service brake, and operates as the duo-servo type (DS type) through electric power (electric motor) at the time of the parking brake.

The drum brake 51 includes the back plate (not shown), the primary shoe 13, the secondary shoe 14, an adjuster 52, the wheel cylinder 53, and a parking brake mechanism 54. The back plate is fixed to a non-rotation portion of the vehicle, and supports the primary shoe 13 and the secondary shoe 14. The primary shoe 13 and the secondary shoe 14 are pressed against the inner peripheral surface of the drum rotor D rotating together with the wheel, to thereby brake the drum rotor D. The primary shoe 13 and the secondary shoe 14 are, for example, the brake shoes 13 and 14 similar to those in the first embodiment, and include the friction materials 33. As the friction materials 33 of the brake shoes 13 and 14, the friction materials 41 in the second embodiment may be used.

The adjuster 52 is provided between the primary shoe 13 and the secondary shoe 14. The adjuster 52 adjusts the gap between the primary shoe 13 and the secondary shoe 14. Moreover, the adjuster 52 transmits a reaction force between the primary shoe 13 and the secondary shoe 14 when the parking brake is operated. The wheel cylinder 53 and the parking brake mechanism 54 are provided to the back plate. The wheel cylinder 53 and the parking brake mechanism 54 form an actuator unit which presses the primary shoe 13 and the secondary shoe 14 against the inner peripheral surface of the drum rotor D.

In the third embodiment, the actuator unit includes the wheel cylinder 53 and the parking brake mechanism 54. The wheel cylinder 53 is positioned on the side of the one end portion of each of the friction materials 33 in arc shapes, in other words, on the side of the first lining portions (first lining materials 34). The wheel cylinder 53 is operated through the hydraulic pressure. For example, the wheel cylinder 53 extends as a result of supply of the hydraulic pressure (brake hydraulic pressure) based on the operation on the brake pedal or the like.

As illustrated in FIG. 7, the wheel cylinder 53 includes a tubular cylinder body 53A and a pair of pistons 53B and 53B which are fit to and inserted into an inside of the cylinder body 53A such that the pistons 53B can displace in an axial direction. A seal ring 53C which seals a gap between an outer peripheral surface of the piston 53B and 53B and an inner peripheral surface of the cylinder body 53A is provided to each of the pistons 53B and 53B. Meanwhile, on a distal end side of one piston 53B. the one end portion of the primary shoe 13 is supported, and, on the distal end side of another piston 53B, the one end portion of the secondary shoe 14 is supported.

When the hydraulic pressure is supplied to the inside of the cylinder body 53A of the wheel cylinder 53, the pistons 53B and 53B displace toward such directions that the pistons 53B and 53B are apart from each other, and the wheel cylinder 53 consequently extends. At this time, the one end side (upper end side of FIG. 7) being the distal end portion of each of the primary shoe 13 and the secondary shoe 14 open while the another end side (lower end side of FIG. 7) serves as turn fulcrum. As a result, the primary shoe 13 and the secondary shoe 14 are pressed against the inner peripheral surface of the drum rotor D, to thereby apply the braking force. The wheel cylinder 53 operates as the leading trailing type (LT type) when the service brake (SB) operates.

The parking brake mechanism 54 is positioned on the side of the another end portion of each of the friction materials 33 in the arc shapes, in other words, on the side of the second lining portions (second lining materials 35). The parking brake mechanism 54 holds the braking force. The parking brake mechanism 54 operates through a rotation force of the electric motor (not shown). That is. the parking brake mechanism 54 is connected to an electric actuator unit (not shown) formed of the electric motor, a speed reducer, a rotation/translation motion conversion mechanism, and the like. Electric power is supplied to the electric motor of the electric actuator unit based on an operation on a parking brake switch, an auto-application command and an auto-release command on the parking brake switch, and the like. As a result, the electric motor rotates, and the parking brake mechanism 54 extends or contracts.

As illustrated in FIG. 7 and FIG. 8, the parking brake mechanism 54 includes a tubular body portion 54A and a pair of pressing pieces 54B and 54B which are fit to and inserted into an inside of the body portion 54A such that the pressing pieces 54B and 54B can displace in an axial direction. The another end portion of the primary shoe 13 is supported on a distal end side of one pressing piece 54B, and the another end portion of the secondary shoe 14 is supported on the distal end side of another pressing piece 54B. The pressing piece 54B and 54B includes a small diameter portion 54B1 which has a small outer diameter dimension. a large diameter portion 54B2 which has a large outer diameter dimension, and a step surface 54B3 which connects the small diameter portion 54B1 and the large diameter portion 54B2 to each other.

When the parking brake mechanism 54 is contracted most, the step surface 54B3 of the pressing piece 54B is in contact with an end surface of the body portion 54A in the axial direction. When the wheel cylinder 53 extends to apply the service brake in this state, the primary shoe 13 and the secondary shoe 14 open while the another end sides serve as the turn fulcrums. Meanwhile, when the parking brake is applied, the parking brake mechanism 54 operates through the rotation of the electric motor. That is. as illustrated in FIG. 8. the parking brake mechanism 54 extends as a result of one pressing piece 54B displacing toward a direction of separating from another pressing piece 54B based on the drive of the electric motor. At this time, the primary shoe 13 is pressed against the drum rotor D, a reaction force thereof is transmitted to the secondary shoe 14 via the adjuster 52, and the primary shoe 13 and the secondary shoe 14 open. As a result, the primary shoe 13 and the secondary shoe 14 are pressed against the inner peripheral surface of the drum rotor D, to thereby apply the braking force. The parking brake mechanism 54 operates as the duo-servo type (DS type) when the parking brake (PKB) operates.

In the third embodiment, the primary shoe 13 and the secondary shoe 14 are pressed against the drum rotor D through use of the wheel cylinder 53 and the parking brake mechanism 54 as described above. and is not particularly different from the first embodiment and the second embodiment. That is, the third embodiment can also reduce the time for the burnish, thereby being capable of suppressing the variation of the brake factor from the initial stage of use.

In particular, in the third embodiment, the parking brake mechanism 54 operates through the rotation force of the electric motor. Thus, the time for the burnish of the drum brake 51 used as the electric parking brake can be reduced. In this case, the parking brake mechanism 54 operates as the duo-servo type. Thus. the time for the burnish of the drum brake 51 used as the electric parking brake of the duo-servo type can be reduced. In other words. also when the configuration of electrically operating the parking brake is employed, that is, when an electric actuator is used to apply the braking force (parking brake), the initial ineffectiveness can be suppressed. As a result. in addition to securing durability of the drum brake 51, the reduction in size and the reduction in weight can be achieved. Moreover, for example, when the electric actuator is used, the responsiveness increases, and hence an increase in output through a reduction in a speed reduction ratio, the reduction in size, and the reduction in weight can be achieved.

In the third embodiment, the actuator unit of the drum brake 51 includes the wheel cylinder 53 and the parking brake mechanism 54. Moreover, the actuator unit 51 operates as the leading trailing type at the time of the operation of the service brake through the wheel cylinder 53. Thus, the time for the burnish of the drum brake 51 used as “the service brake of the leading trailing type” and “the electric parking brake of the duo-servo type” can be reduced. Further, the sufficient burnish is achieved in a wide range of the sliding surface (friction surface or sliding surface) of the friction material 33 from the initial stage of use, and hence a stroke of the parking brake mechanism 54 used for deflection of the brake shoes 13 and 14 at the time of the operation of the drum brake 51 is reduced, with the result that high rigidity can be obtained. Moreover, the high rigidity can stably be achieved for small input to large input in a period from the initial stage of use to the time of replacement of the friction material 33, and hence the set value of the TSCC through the automatic adjuster mechanism can be small. As a result. also in this respect, the ineffective stroke of the parking brake mechanism 54 can be reduced. As a result, when the parking brake mechanism 54 is operated through the parking pedal or the parking brake lever in the vicinity of the driver seat, the good operation feeling can be obtained.

In each embodiment, as a representative example of the drum brake 2, description is given of the example case of the drum brake mounted to a motor vehicle. more specifically, a four-wheeled motor vehicle. However, the application of the drum brake is not limited to this example, and the drum brake can widely be applied as a drum brake mounted to various vehicles, for example, a drum brake mounted to a two-wheeled vehicle, a drum brake mounted to a work vehicle such as a forklift and a wheel loader, and a drum brake mounted to a railroad vehicle. Further, each embodiment is merely an example, and it is apparent that the configurations described in the different embodiments can be partially replaced or combined.

According to the embodiment described above. the friction material of the braking member includes the first lining portion being the one end portion in the rotation direction of the drum rotor, the second lining portion being the another end portion, and the third lining portion positioned between the one end portion and the another end portion. Moreover, the third lining portion is produced such that the third lining portion wears earlier than the first lining portion and the second lining portion. Thus, when the braking members are burnished on the drum rotor. the wear of the third lining portions become earlier, and hence the time for the burnish can be reduced. As a result, the variation of the brake factor can be suppressed from the initial stage of use.

According to the embodiment, the first lining portion, the second lining portion, and the third lining portion are the individual first lining material, second lining material. and third lining material. respectively. In other words. the friction material is divided into at least the three lining materials of the first lining material, the second lining material, and the third lining material. Moreover. the first lining material and the third lining material has the first gap portion therebetween, and the second lining material and the third lining material has the second gap portion therebetween. The first gap portion and the second gap portion can be used as the gaps for the water drainage. That is, when the water infiltrates between the drum rotor and the braking member as a result of passage over a puddle or the like, this water can be drained via the first gap portion and the second gap portion. As a result, the water drainage capability can be increased, and hence the recovery capability from the water fade can be increased.

According to the embodiment, the first gap portion and the second gap portion have shapes different from each other. Accordingly, assembly of erroneous lining material (erroneous assembly) can be suppressed when the lining materials are assembled to the outer peripheral surface of the rim of the shoe body.

According to the embodiment, the third lining portion is different in mixing component or mixing ratio of the material from the first lining portion and the second lining portion. Thus, promotion of the wear of the third lining portion can be facilitated by differentiating the mixing component or the mixing ratio of the material.

According to the embodiment, the porosity in the third lining portion is higher than the porosities in the first lining portion and the second lining portion. Thus, a density of the third lining portion can be set low, and hence the promotion of the wear of the third lining portion can be facilitated.

According to the embodiment, the groove portion is provided on the outer peripheral surface of the third lining portion. The number of groove portions may be one or two or more. and, moreover. the groove portion may be formed of one groove, or may be formed of the plurality of grooves. In any case, the contact area (width of the contact portion) with the drum rotor at the braking time can be reduced by providing the groove portion. As a result, the promotion of the wear of the third lining portion can be facilitated. In this case, the range in which the promotion of the wear is facilitated can be restricted by, for example, adjusting the position for providing the groove portion and the depth thereof. Thus, even when the first lining portion, the second lining portion. and the third lining portion are formed of, for example, one lining material, the promotion of the wear of the third lining portion can be facilitated by providing the groove portion in the portion corresponding to the third lining portion. Moreover, the period in which the promotion of the wear is facilitated can be adjusted in accordance with the depth of the groove portion. Thus, for example, the promotion of the wear can be facilitated at only the initial stage of use by reducing the depths in the groove portion.

According to the embodiment, the groove portion has the groove width in the depth direction gradually decreasing from the outer peripheral surface of the third lining portion toward the direction of the rotation center of the drum rotor. Thus, the contact area of the third lining portion increases due to the groove width decreasing as the wear progresses. As a result, the promotion of the wear of the third lining portion at the initial stage of use can be facilitated. As a result, “the reduction in the time for the burnish” and “the securing durability (life until replacement) of the friction material” can simultaneously be achieved at a high level.

According to the embodiment,, the plurality of grooves forming the groove portion are different from each other in depth and groove width. Thus, the promotion of the wear of the third lining portion can be facilitated by differentiating the depths and the groove widths (for example, the widths in the depth direction. the widths in the circumferential direction. the widths in the radial direction, and the like) of the plurality of grooves.

According to the embodiment, the actuator unit includes the parking brake mechanism that holds the braking force. Thus, the time for the burnish of the drum brake used as the parking brake can be reduced.

According to the embodiment, the parking brake mechanism operates through the rotation force of the electric motor. Thus, the time for the burnish of the drum brake used as the electric parking brake can be reduced.

According to the embodiment, the parking brake mechanism operates as the duo-servo type. Thus, the time for the burnish of the drum brake used as the (electric) parking brake of the duo-servo type can be reduced.

According to the embodiment, the actuator unit includes the wheel cylinder and the parking brake mechanism. Moreover, the actuator unit operates as the leading trailing type at the time of the operation of the service brake through the wheel cylinder. Thus, the time for the burnish of the drum brake 51 used as “the service brake of the leading trailing type” and “the (electric) parking brake of the duo-servo type” can be reduced.

Note that, the present invention is not limited to the embodiments described above, and includes further various modification examples. For example, in the embodiments described above, the configurations are described in detail in order to clearly describe the present invention, but the present invention is not necessarily limited to an embodiment that includes all the configurations that have been described. Further, a part of the configuration of a given embodiment can replace the configuration of another embodiment, and the configuration of another embodiment can also be added to the configuration of a given embodiment. Further, another configuration can be added to. deleted from. or replace a part of the configuration of each of the embodiments.

The present application claims a priority based on Japanese Patent Application No. 2021-113249 filed on Jul. 8, 2021. All disclosed contents including Specification, Scope of Claims, Drawings, and Abstract of Japanese Patent Application No. 2021-113249 filed on Jul. 8, 2021 are incorporated herein by reference in their entirety.

### Reference Signs List

2, 51: drum brake, 11: back plate, 13: primary shoe (braking member), 14: secondary shoe (braking member), 20: lever (actuator unit, parking brake mechanism), 33, 41: friction material, 34: first lining material (first lining portion), 35: second lining material (second lining portion), 36: third lining material (third lining portion), 37: first gap portion, 38: second gap portion, 42A: first lining portion, 42B: second lining portion, 42C: third lining portion, 43: groove portion. 43A. 43B: groove, 53: wheel cylinder, 54: parking brake mechanism, D: drum rotor

1. A drum brake, comprising:
a braking member configured to brake a drum rotor by being pressed against an inner peripheral surface of the drum rotor rotating together with a wheel, the braking member including:
a first lining portion that is one end portion of a friction material in an arc shape opposing the inner peripheral surface of the drum rotor in a rotation direction of the drum rotor;
a second lining portion that is another end portion of the friction material in the rotation direction of the drum rotor; and
a third lining portion that is positioned between the one end portion and the another end portion in the rotation direction of the drum rotor, and is produced such that the third lining portion wears earlier than the first lining portion and the second lining portion;
a back plate that is configured to support the braking member, and is fixed to a non-rotation portion of a vehicle; and
an actuator unit configured to press the braking member against the inner peripheral surface of the drum rotor.

2. The drum brake according to claim 1,
wherein the first lining portion is a first lining material, the second lining portion is a second lining material, and the third lining portion is a third lining material,
wherein the first lining material and the third lining material has a predetermined first gap portion therebetween, and
wherein the second lining material and the third lining material has a predetermined second gap portion therebetween.

3. The drum brake according to claim 2, wherein the first gap portion has a shape different from the shape of the second gap portion as viewed from a side of the inner peripheral surface of the drum rotor.

4. The drum brake according to claim 1, wherein the third lining portion is different in mixing component or mixing ratio of a material from the first lining portion and the second lining portion.

5. The drum brake according to claim 1, wherein a porosity in the third lining portion is higher than porosities in the first lining portion and the second lining portion.

6. The drum brake according to claim 1, wherein a groove portion is provided on an outer peripheral surface of the third lining portion.

7. The drum brake according to claim 6, wherein the groove portion has a groove width in a depth direction gradually decreasing from the outer peripheral surface of the third lining portion toward a direction of a rotation center of the drum rotor.

8. The drum brake according to claim 7,
wherein the groove portion includes a plurality of grooves, and
wherein the plurality of grooves are different from one another in depth and groove width in each of the plurality of grooves.

9. The drum brake according to claim 1, wherein the actuator unit includes a parking brake mechanism that holds a braking force.

10. The drum brake according to claim 9, wherein the parking brake mechanism operates through a rotation force of an electric motor.

11. The drum brake according to claim 10, wherein the parking brake mechanism operates as a duo-servo type.

12. The drum brake according to claim 11, wherein the actuator unit includes:
a wheel cylinder that is provided on a side of the one end portion, and is configured to operate through a hydraulic pressure; and
the parking brake mechanism that is provided on a side of the another end portion, and is configured to operate as a leading trailing type when a service brake operates.

13. A braking member configured to brake a drum rotor by being pressed against an inner peripheral surface of the drum rotor rotating together with a wheel, the braking member comprising:
a first lining portion that is one end portion of a friction material in an arc shape opposing the inner peripheral surface of the drum rotor in a rotation direction of the drum rotor;
a second lining portion that is another end portion of the friction material in the rotation direction of the drum rotor; and
a third lining portion that is positioned between the one end portion and the another end portion in the rotation direction of the drum rotor, and is produced such that the third lining portion wears earlier than the first lining portion and the second lining portion.
